(19) United States
(12) Patent Application Publication
(10) Pub. No.: US 2026/0024976 A1
(43) Pub. Date: Jan. 22, 2026

(54) Height Adjustable Charging Grommet

(71) Applicant: SQUARE GROVE LLC, Austin, TX (US)

(72) Inventors: Shane Gilbreath, Georgetown, TX (US); Eric W. Anderson, Austin, TX (US)

(21) Appl. No.: 18/776,149

(22) Filed: Jul. 17, 2024

(51) Int. Cl. H02G 3/22; A47B 21/06

(52) U.S. Cl. CPC H02G 3/22; A47B 21/06

(57) ABSTRACT

A height adjustable charging grommet can include a grommet sleeve and a grommet cap. The grommet cap can include a charging surface and one or more legs. The grommet sleeve can include one or more longitudinal channels on an inner portion of a sleeve wall. One or more of the legs of the grommet cap can fit within the longitudinal channels. One or more of the longitudinal channels include a respective floor tab. The floor tabs can be positioned at different heights relative to one another.

### BACKGROUND

Tabletops and desks often have a number of electronic devices placed on top of them by a user who is using the tabletop or desk as a workspace and each of these devices may have different size cables needing to be attached to them. Further, some of those devices may be charged wirelessly on a charging surface. Being able to accommodate multiple cables to be fitted from under the desk to the desk surface while also providing a charging surface may be beneficial.

### SUMMARY

Implementations disclosed herein relate to a height adjustable charging grommet which allows for multiple sized cables to be fed through the cable feed aperture of the desk. In some implementations, cables are fed through an aperture in the desk to the desk surface for multiple electronic devices and for connectivity. These differing sized cables may be accommodated while also providing a wireless charging surface on the desk surface. Therefore, a height adjustable charging surface, or grommet, on a desk may be provided wherein the charging surface is height adjustable and/or may be moved to another location on the surface. Providing height adjustability of the wireless charging grommet while allowing for multiple cables or electronic connector sizes and also allowing for the wireless charging surface to be completely removed from the sleeve and placed closer to the front of the desk provides for ease of use, organization of charging and connectivity cables and ease of use of the charging surface. Additionally, complete removal of the wireless charger from the desk aperture may be desirable since most of the desk apertures are positioned at the farthest point of the desk away from the seating area.

The height adjustable charging grommet can include a grommet sleeve which fits into the desk aperture feeding the wires from below the desk to the desk surface. The grommet sleeve which fits into the desk aperture can have a sleeve wall with an interior surface. The sleeve can include a flange at least partially circumscribing an outer portion of the top of the grommet sleeve. The grommet sleeve can also have a plurality of longitudinally extending channels on an inner portion of the sleeve wall for receiving the charging grommet. One or more of the longitudinally extending channels can include a floor tab at some point along the length of the channel. These floor tabs allow for the charging grommet to be held in place at different heights relative to the grommet sleeve. The height adjustable charging grommet may further include a removeable grommet cap which is received within the grommet sleeve, the charging grommet able to be positioned at varying vertical positions relative to the grommet sleeve flange. The removeable grommet cap can include one or more of a charging surface, one or more legs, and/or a sidewall. Further, one or more of the legs of the charging grommet can each fit within a respective longitudinally extending channel of the plurality of longitudinally extending channels of the grommet sleeve. Hence, in combination with the floor tabs, the charging grommet can fit within the grommet sleeve, matching at least one of the legs within at least one channel having a floor tab, to adjust the height of the charging grommet and hence the gap or opening under the charging surface for cables to extend through.

The top charging surface may have a depending sidewall that extends downward from the charging surface to the legs. The sidewall can be continuous or discontinuous. The shape of the sidewall can also vary, including but not limited to annular and/or rectangular. One or more cutouts can be included in the sidewall. For example, a section of the sidewall between one or more of the legs can be removed. Further, extending downward from the removable grommet top surface may be at least one depending leg which can fit within the channels of the grommet insert.

The plurality of longitudinally extending channels on the inner surface of the grommet sleeve that is fitted within the desk aperture may include a first channel longitudinally extending channel, a second longitudinally extending channel, and/or a third longitudinally extending channel. Each of these channels may be sized to fit portions of the depending legs of the charging grommet. The first longitudinally extending channel can have a first floor tab and the second longitudinally extending channel can have a second floor tab. In some embodiments the floor tabs are positioned at differing relative heights and in other embodiments the floor tabs are positions at the same relative height. The first longitudinally extending channel may be adjacent to the second longitudinally extending channel or alternatively may be positioned anywhere on the grommet sleeve relative to each other. The first and second floor tabs can be positioned at different relative heights or at the same relative height. In some embodiments, the third longitudinally extending channel may not include a floor tab thereby allowing the removable charging grommet to slide all the way into the grommet sleeve and be flush with the grommet sleeve flange and desk surface.

In various embodiments, the plurality of longitudinally extending channels can each have a pair of separated guide walls which define the channel. These guide walls can be set a predetermined distance apart which is slightly larger than the legs of the charging grommet. The guide walls can be generally orthogonal to the inner portion of the sleeve wall. A first longitudinally extending channel and a second longitudinally extending channel, of the plurality of longitudinally extending channels, can share a particular guide wall, of the pair of guide walls. Each of the floor tabs can extend between a respective pair of guide walls. One or more of the legs can be received between one or more of the pairs of guide walls. As well, positions of the floor tabs within channels receiving matching legs of the charging grommet can be at the same relative vertical height within the grommet sleeve. For example, if the charging grommet has three legs positioned at equidistant locations, the floor tabs in the set of receiving channels (and for all so related channels) will be in coordinated relative locations.

In some implementations, the plurality of longitudinally extending channels can include a first, a second, a third, and/or a fourth set of longitudinally extending channels on the inner portion of the sleeve wall. Each of the second, the third, and the fourth sets of longitudinally extending channels can have a floor tab. The floor tabs of each of the second, the third, and the fourth sets of longitudinally extending channels can each be positioned at a different relative height. For example, the floor tabs of the second set of longitudinally extending channels can be positioned at a first relative height on the inner portion of the sleeve wall. The floor tabs of the third set of longitudinally extending channels can be positioned at a second relative height on the inner portion of the sleeve wall. The floor tabs of the fourth set of longitudinally extending channels can be positioned at a third relative height on the inner portion of the sleeve wall. The first relative height may be greater than the second relative height, and the second relative height may be greater than the third relative height.

The first, the second, the third, and the fourth sets of longitudinally extending channels can each include a first, a second, and/or a third longitudinally extending channel. Each of the first longitudinally extending channels of the first, the second, the third, and/or the fourth sets of longitudinally extending channels can be positioned adjacent to another one of the first longitudinally extending channels of the first, the second, the third, and/or the fourth sets of longitudinally extending channels. Each of the second longitudinally extending channels of the first, the second, the third, and/or the fourth sets of longitudinally extending channels can be adjacent to another one of the second longitudinally extending channels of the first, the second, the third, and/or the fourth sets of longitudinally extending channels. Each of the third longitudinally extending channels of the first, the second, the third, and/or the fourth sets of longitudinally extending channels can be adjacent to another one of the third longitudinally extending channels of the first, the second, the third, and/or the fourth sets of longitudinally extending channels. Each of the fourth longitudinally extending channels of the first, the second, the third, and/or the fourth sets of longitudinally extending channels can be adjacent to another one of the fourth longitudinally extending channels of the first, the second, the third, and/or the fourth sets of longitudinally extending channels.

### BRIEF DESCRIPTION OF THE DRAWINGS

FIG. 1 depicts a perspective view of a height adjustable charging grommet as described herein.

FIG. 2A depicts a side perspective of a grommet cap as described herein.

FIG. 2B depicts a bottom perspective of the grommet cap as described herein.

FIG. 3A depicts a top perspective view of a grommet sleeve as described herein.

FIG. 3B depicts a section view of a grommet sleeve as described herein.

FIG. 4A-D depict a height adjustable charging grommet where a grommet cap is inserted into a grommet sleeve and adjusted to varying heights as described herein.

### DETAILED DESCRIPTION

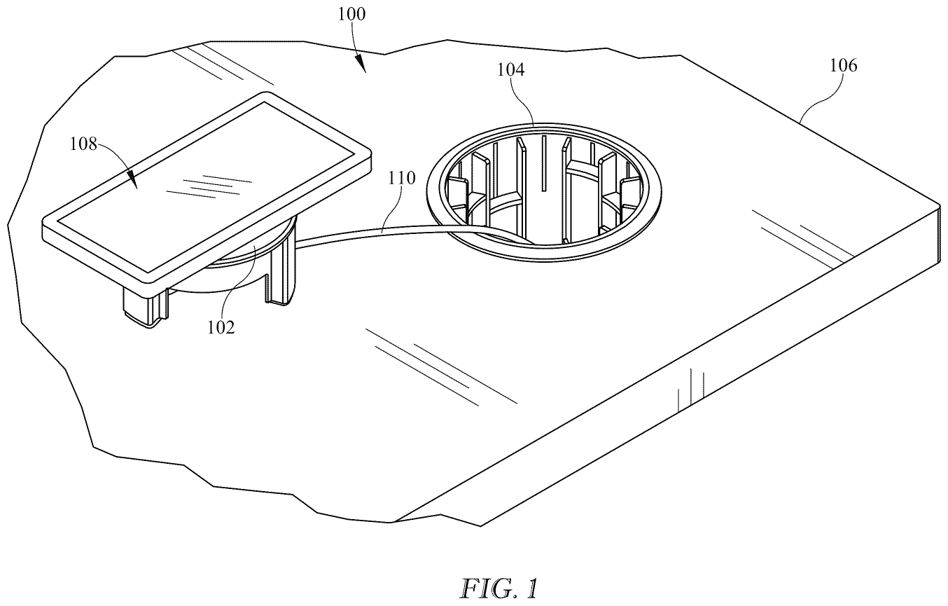

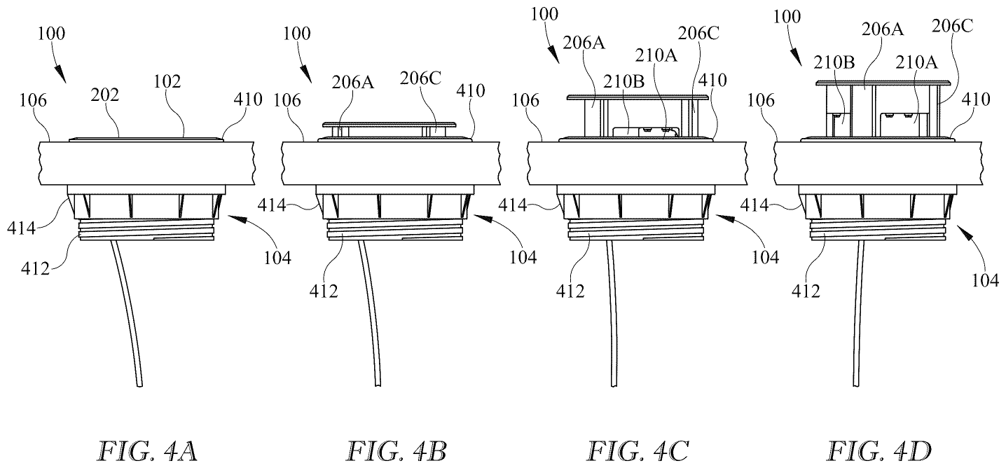

Referring to FIG. 1, a perspective view of view of a height adjustable charging grommet 100 is depicted. The height adjustable charging grommet 100 can include a grommet cap 102 and a grommet sleeve 104. The grommet sleeve 104 can be inserted into a desk aperture which is formed in the desk surface 106. Typically, these apertures are provided to feed wires through the aperture and to the desk top surface. These cables or wires can be differing thicknesses and also any given user may have multiple wires fed through the desk aperture. When not in use, the aperture may have a grommet cap for decorative covering but it is helpful to allow for both charging and adjustability so these various wires and cords can be fed through the aperture for use by the office worker. Typically, the aperture is covered by a grommet cap and here grommet cap 102 can also serve as a charging surface while also being adjustable as depicted in FIG. 1. Further, the grommet cap 102 can be completely removed to place it closer to the office worker for charging devices. Hence, the adjustable charging grommet 100 including charging surface and cap 102 can be adjusted for differing heights, as shown in FIGS. 4A-4D, and also completely removable, as depicted in FIG. 1.

The grommet cap 102 can be inserted into the grommet sleeve 104, described with respect to FIG. 4A-D, and can also be removed from the grommet sleeve 104 and be placed on the surface 106. The grommet cap 102 can function as a wireless charging device such that an electronic device 108, can be placed atop the grommet cap 102 and recharge its battery. The grommet cap 102 can be connected to a power source via a cable 110. The cable 110 can be attached to the grommet cap 102 and then be passed through the grommet sleeve 104. Alternatively, the grommet cap 102 can be powered by an internal battery.

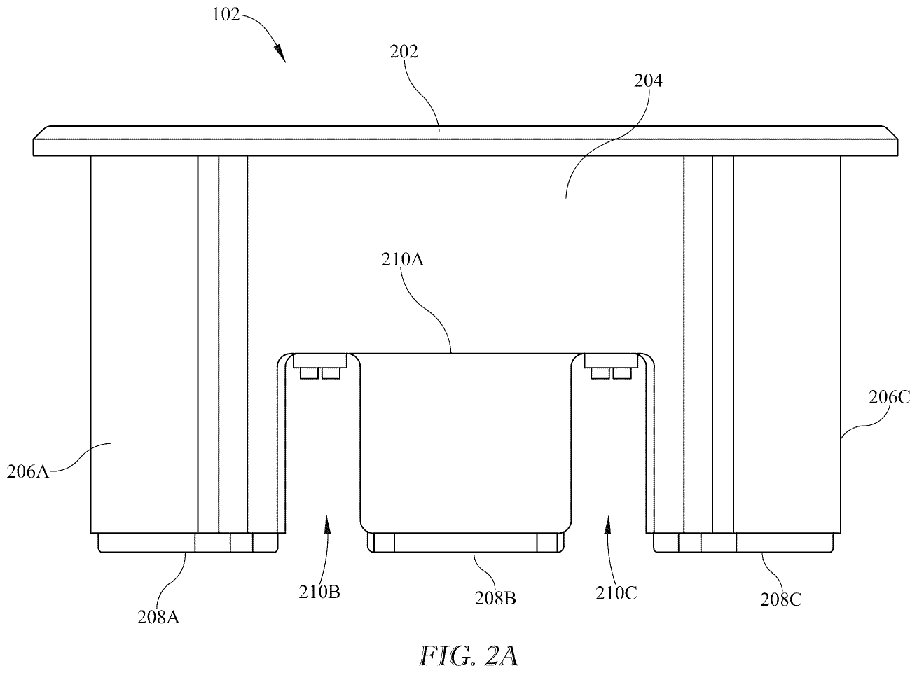

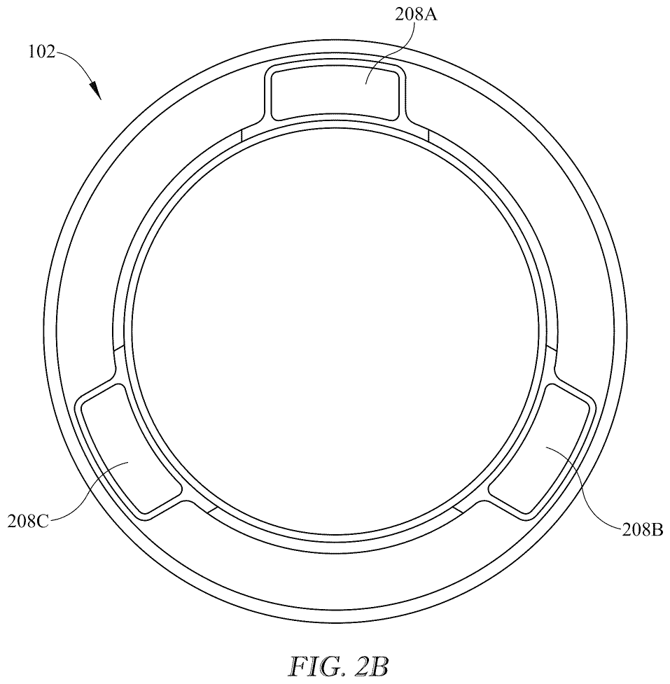

Referring now to FIGS. 2A and 2B. In FIG. 2A, a side perspective of a grommet cap 102 is depicted. In FIG. 2B, a bottom perspective of the grommet cap 102 is depicted. The grommet cap 102 can include any combination of a charging surface 202, a sidewall 204, one or more legs 206A-C, and/or end caps 208A-C. The sidewall 204 can include one or more cutouts 210A-C.

In some implementations, the whole of the charging surface 202 is capable of charging an electronic device 108. Alternatively, in some implementations, only a portion of the charging surface 202 can charge an electronic device 108.

One or more of the legs 206A-C can extend generally orthogonally from the charging surface 202. A top edge of the legs 206A-C can abut the charging surface 202. A portion of the charging surface 202 can overhang one or more of the legs 206A-C. A bottom edge of the legs 206A-C can each have an endcap 208A-C attached to it. In some implementations, the endcaps 208A-C can be inserted into an opening in the bottom edge of each of the legs 210A-C.

Alternatively, the end caps 208A-C can be fitted around the bottom edge of the legs 210A-C or can be attached to the bottom edge of the legs 210A-C with an adhesive and/or a fastener, or can be press fit to the legs 210A-C. The endcaps 208A-C can be made of rubber, plastic, or any other suitable material.

A sidewall 204 can extend between one or more of the legs 206A-C. The sidewall 204 can extend between any of combination of the legs 206A-C or all of the legs 206A-C. The sidewall 204 can be one continuous member or can be split into different sections. The charging surface 202 and the sidewall 204 can have complimentary shapes. For example, the sidewall 204 can be an annular sidewall 204 and the charging surface 202 can be generally round. Alternatively, a rectangular sidewall 204 can be accompanied by a rectangular charging surface 202. The charging surface 202 can have a surface area that is larger than a cross-sectional area of the sidewall 204 such that the charging surface 202 can overhang the edges of the sidewall 204.

The sidewall can include one or more of the cutouts 210A-C. One or more of the cutouts 210A-C can extend upwards from a bottom edge of the sidewall 204. Each of the cutouts 210A-C can be the same size, or alternatively, can be varying sizes.

The cutouts 210A-C can be positioned similarly around the sidewall 204. For example, each of the cutouts 210A-C can extend upwards a same distance from the bottom edge of the sidewall 204. Alternatively, one or more of the cutouts 210A-C can each extend varying distances up the side wall/For example, 210A can extend upwards a first distance up the sidewall, 210B can extend upwards a second distance up the sidewall, and 210C can extend upwards a third distance up the sidewall, where the first distance is greater than the second distance and the second distance is greater than the third distance. When a user adjusts the height of the grommet cap 102 when it is placed in the grommet sleeve 104, the cutout 210A can be visible before 210B, which can be visible before 210C. This will be described in more detail with respect to FIGS. 4A-D. In some other implementations, one or more of the cutouts 210A-C can be integral with the sidewall 204 without extending from one of the edges. One or more of the cutouts 210A-C in these implementations can be positioned at varying positions on the sidewall 204 relative to a top and/or bottom edge of the sidewall 204.

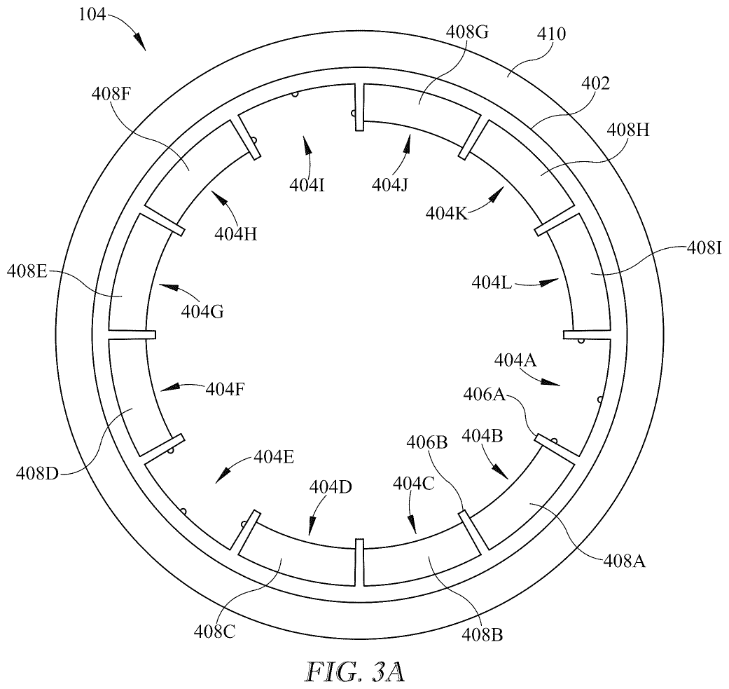

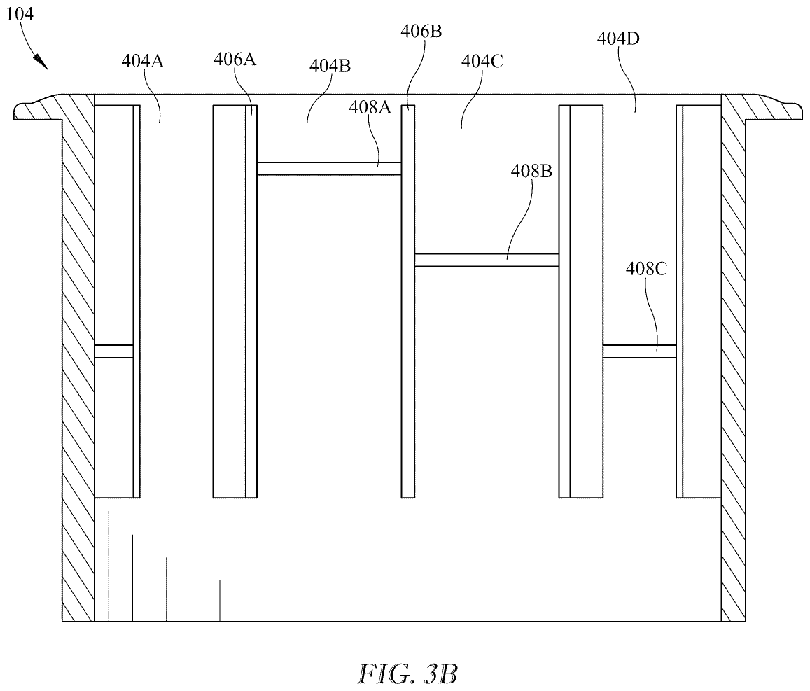

Referring now to FIGS. 3A and 3B. FIG. 3A depicts a top perspective view of a grommet sleeve 104 and FIG. 3B depicts a section view of a grommet sleeve 104. The grommet sleeve 104 can include a sleeve wall 402 and a flange 410. The flange can at least partially circumscribe the outer portion of the sleeve wall 402. For example, the flange 410 can be one continuous member that circumscribes the entirety of the outer portion of the sleeve wall 402. The flange 410 can be one continuous member that circumscribes only a single section of the outer portion of the sleeve wall. Alternatively, the flange 410 can be multiple members that circumscribe the entirety of the outer portion of the sleeve wall 402, or the flange 410 can be multiple members that circumscribe multiple partial sections of the outer portion of the sleeve wall 402. In some implementations, the grommet sleeve 104 may not include a flange 410.

The grommet sleeve 104 can include a plurality of longitudinally extending channels 404A-L. The longitudinally extending channels 404A-L can at least partially circumscribe an inner portion of the sleeve wall 402 of the grommet sleeve 104. The longitudinally extending channels can each be formed by a pair of guide walls 406A-B. The guide walls 406A-B can be generally orthogonal to the sleeve wall 402 and extend outward from the sleeve wall 402 towards the center of the grommet sleeve 104. Each of the guide walls 406A-B can begin at or near the top of the sleeve wall 402 of the grommet sleeve 104 and end at or near the bottom of the sleeve wall 402 of the grommet sleeve 104. Adjacent longitudinally extending channels 404A-L can share a guide wall 404A-B. For example, longitudinally extending channel 404A and longitudinally extending channel 404B can share a guide wall 406A. In some implementations, the guide walls 404A-B can be integral with the longitudinally extending channels 404A-L and/or the sleeve wall 402. In other implementations, the guide walls 404A-B can be separate members from the longitudinally extending channels 404A-L and/or the sleeve wall 402.

One or more of the longitudinally extending channels 404A-L can include a floor tab 408A-I, while one or more of the longitudinally extending channels 404A-L may not include a floor tab 408A-I. For example, longitudinally extending channels 404B-D include floor tabs 408A-C, longitudinally extending channels 404F-H include floor tabs 408D-F and longitudinally extending channels 404J-L include floor tabs 408G-I, respectively, while longitudinally extending channels 404A, 404E, and 404I do not include a floor tab 408A-I. Each of the floor tabs 408A-I can extend between the guide walls 406A-B of the respective longitudinally extending channels 406A-L. In some implementations, the floor tabs 408A-I can be integral with the longitudinally extending channels 406A-L and/or the sleeve wall 402. In other implementations, the floor tabs 408A-I can be separate members from the longitudinally extending channels 406A-L and/or the sleeve wall 402.

Some of the floor tabs 408A-I can be at different heights relative to one another. The height of each of the floor tabs 408A-I can measured relative to the height of another one of the floor tabs 408A-I. For example, floor tab 408A, can be adjacent to floor tab 408B, and floor tab 408A can be higher relative to floor tab 408B. Similarly, floor tab 408B can be adjacent to floor tab 408C, and floor tab 408B can be higher relative to floor tab 408C.

The longitudinally extending channels 404A-L can be arranged in a particular pattern. For example, longitudinally extending channel 404A may not include a floor tab 408A-I. Longitudinally extending channel 404B can be positioned adjacent to longitudinally extending channel 404A. Longitudinally extending channel 404B can include floor tab 408A, which can be positioned at a particular height on the sleeve wall 402 of the grommet sleeve 104. Longitudinally extending channel 404C can be positioned adjacent to longitudinally extending channel 404B and can include floor tab 408B. Floor tab 408B can be positioned at a height that is lower relative to floor tab 408A. Longitudinally extending channel 404D can be adjacent to longitudinally extending channel 404C and can include floor tab 408C. Floor tab 408C can be positioned at a height that is lower relative to floor tab 408B. This pattern can be repeated until the longitudinally extending channels 404A-L circumscribe the sleeve wall 402 of the grommet sleeve 104. In some implementations, the pattern can be reversed or mixed such that the heights of adjacent floor tabs 408A-I increase or both increase and decrease relative to one another.

Referring now to FIGS. 4A-D. FIGS. 4A-D depict a height adjustable charging grommet 100 where a grommet cap 102 is inserted into a grommet sleeve 104 and adjusted to varying heights. The grommet sleeve 104 can be inserted into a hole in a surface 106, or such as a table or a desk. The grommet sleeve 104 can be held in place and prevented from falling through the hole in the surface 106 by the flange 410. The grommet sleeve 104 can include threaded rings 412. The threaded rings 412 of the grommet sleeve 104 can circumscribe an outer portion of the sleeve wall 402.

In some implementations, a locking ring 414 can be attached to the threaded rings 412 of the grommet sleeve 104. The locking ring 414, in other implementations, may be attached to the grommet sleeve 104 in a variety of other ways, such as with snap locks or clips. When the grommet sleeve 104 is inserted into the hole in the surface 106, a user may attach the locking ring 414 to the grommet sleeve 104 by screwing the locking ring 414 onto the threaded rings 412. The locking ring 414 can have a cross-sectional area that is greater than the cross-sectional area of the hole in the surface 106. When the locking ring 414 is screwed onto the threaded rings 412 of the grommet sleeve 104, the locking ring 414 can contact an underside of the surface 106. The grommet sleeve 104 can be prevented from being removed from the hole in the surface 106 by the locking ring 414.

When the grommet cap 102 is inserted into the grommet sleeve 104, one or more of the legs 206A-C of the grommet cap 102 depicted in FIGS. 2A and 2B, can be aligned with and inserted into one or more of the longitudinally extending channels 404A-L d depicted in FIGS. 3A and 3B. The guide walls 406A-B of each longitudinally extending channel 404A-L depicted in FIGS. 3A and 3B can secure the legs 206A-C in place and prevent the grommet cap 102 from rotating inside the grommet sleeve 104.

FIG. 4A depicts a grommet cap 102 that has been fully inserted into a grommet sleeve 104. In some embodiments when the grommet cap 102 is fully inserted into the grommet sleeve 104, one or more of the legs 206A-C can be inserted into one or more longitudinally extending channels 404A, 404E, and/or 404I that do not have a floor tab 408A-I. The overhanging portion of the charging surface 202 can rest on the flange 410 of the grommet sleeve 104 and prevent the grommet cap 102 from falling through the grommet sleeve 104. Alternatively, the charging surface 202 can rest atop the guide walls 406A-B of one or more of the longitudinally extending channels 404A-B and prevent the grommet cap 102 from falling through the grommet sleeve 104. In yet other embodiments, one or more of the legs 206A-C can be inserted into longitudinally extending channels 404A-L that include floor tabs 408A-I that are positioned at such a height as to allow the grommet cap 102 to be fully inserted into the grommet sleeve 104. The legs 206A-C can rest atop the floor tabs 408A-C to prevent the grommet cap 102 from falling through the grommet sleeve 104.

FIG. 4B depicts a grommet cap 102 that has been inserted into a grommet sleeve 104 at a first height. For example, the legs 206A-C can be inserted into longitudinally extending channels 404D, 404H, and 404L that can have floor tabs 408C, 408F, and 408I respectively. The floor tabs 408C, 408F, and 408I can be positioned at a particular height as to allow only a portion of the sidewall 204 to be exposed above the surface 106, without exposing any of the cutouts 210A-C.

FIG. 4C depicts a grommet cap 102 that has been inserted into a grommet sleeve 104 at a second height. For example, the legs 206A-C can be inserted into longitudinally extending channels 404C, 404G, and 404K that can have floor tabs 408B, 408E, and 408H respectively. The floor tabs 408B, 408E, and 408H can be positioned at a particular height as to allow only a portion of the sidewall 204 and a portion of one or more of the cutouts 210A-C to be exposed above the surface 106. The floor tabs 408A, 408D, and 408G can be positioned relatively higher than floor tabs 408C, 408F, and 408I. The exposure of the cutouts 210A-C can allow wires or cables to be passed through the grommet 100 while the grommet cap 102 is still inserted into the grommet sleeve 104.

FIG. 4D depicts a grommet cap 102 that has been inserted into a grommet sleeve 104 at a third height. For example, the legs 206A-C can be inserted into longitudinally extending channels 404J, 404G, and 404K that can have floor tabs 408A, 408D, and 408G respectively. The floor tabs 408A, 408D, and 408G can be positioned at a particular height as to expose the entirety, or at least a larger portion than in FIGS. 4B and 4C, of the sidewall 204 and to expose the entirety, or at least a larger portion than in FIGS. 4B and 4C, of one or more of the cutouts 210A-C, above the surface 106. The floor tabs 408A, 408D, and 408G can be positioned relatively higher than floor tabs 408A, 408D, and 408G. The greater exposure of the cutouts 210A-C can allow more and or larger wires or cables to be passed through the grommet 100 while the grommet cap 102 is still inserted into the grommet sleeve 104.

What is claimed is:

1. A height adjustable charging grommet, comprising:
a grommet sleeve having a sleeve wall and a flange at least partially circumscribing an outer portion of the sleeve wall, the grommet sleeve including a plurality of longitudinally extending channels on an inner portion of the sleeve wall, at least one of the longitudinally extending channels having a floor tab; and
a removeable grommet cap received within the grommet sleeve, the removeable grommet cap having a charging surface and one or more legs, wherein at least one of the one or more of the legs fit within a respective longitudinally extending channel of the plurality of longitudinally extending channels of the grommet sleeve.

2. The height adjustable charging grommet of claim 1, wherein the removeable grommet cap further includes a depending sidewall, wherein the depending sidewall of the removeable grommet cap extends between one or more of the legs.

3. The height adjustable charging grommet of claim 2, wherein the depending sidewall of the removeable grommet cap is an annular sidewall.

4. The height adjustable charging grommet of claim 2, wherein the depending sidewall includes one or more cutouts between a first leg and a second leg of the one or more legs.

5. The height adjustable charging grommet of claim 1, wherein the plurality of longitudinally extending channels of the grommet sleeve include a first channel longitudinally extending channel and a second longitudinally extending channel, wherein the first longitudinally extending channel includes a first floor tab and the second longitudinally extending channel includes a second floor tab.

6. The height adjustable charging grommet of claim 5, wherein the first longitudinally extending channel is adjacent to the second longitudinally extending channel and wherein the first floor tab is positioned on the sleeve wall at a different relative height than the second floor tab.

7. The height adjustable charging grommet of claim 5, wherein the first floor tab and the second floor tab are positioned on the sleeve wall at a same relative height.

8. The height adjustable charging grommet of claim 5, wherein the plurality of longitudinally extending channels further includes a third longitudinally extending channel, wherein the third longitudinally extending channel does not include a floor tab.

9. The height adjustable charging grommet of claim 1, wherein the plurality of longitudinally extending channels include a pair of guide walls that are generally orthogonal to the inner portion of the sleeve wall.

10. The height adjustable charging grommet of claim 9, wherein a first longitudinally extending channel and a second longitudinally extending channel, of the plurality of longitudinally extending channels, share a particular guide wall, of the pair of guide walls.

11. A grommet sleeve, comprising:
a sleeve wall and a flange at least partially circumscribing an outer portion of the sleeve wall; and
a first, a second, a third, and a fourth set of longitudinally extending channels on an inner portion of the sleeve wall, each of the second, the third, and the fourth sets of longitudinally extending channels having a floor tab, wherein the floor tabs of the second set of longitudinally extending channels are positioned at a first relative height on the inner portion of the sleeve wall, the floor tabs of the third set of longitudinally extending channels are positioned at a second relative height on the inner portion of the sleeve wall, and the floor tabs of the fourth set of longitudinally extending channels are positioned at a third relative height on the inner portion of the sleeve wall.

12. The grommet sleeve of claim 11, wherein the first relative height is greater than the second relative height, and the second relative height is greater than the third relative height.

13. The grommet sleeve of claim 11, wherein each of the first, the second, the third, and the fourth sets of longitudinally extending channels include a first, a second, and a third longitudinally extending channel.

14. The grommet sleeve of claim 13, wherein each of the first longitudinally extending channels of the first, the second, the third, and the fourth sets of longitudinally extending channels are adjacent to another one of the first longitudinally extending channels of the first, the second, the third, and the fourth sets of longitudinally extending channels.

15. The grommet sleeve of claim 14, wherein each of the second longitudinally extending channels of the first, the second, the third, and the fourth sets of longitudinally extending channels are adjacent to another one of the second longitudinally extending channels of the first, the second, the third, and the fourth sets of longitudinally extending channels.

16. The grommet sleeve of claim 15, wherein each of the third longitudinally extending channels of the first, the second, the third, and the fourth sets of longitudinally extending channels are adjacent to another one of the third longitudinally extending channels of the first, the second, the third, and the fourth sets of longitudinally extending channels.

17. The grommet sleeve of claim 16, wherein each of the fourth longitudinally extending channels of the first, the second, the third, and the fourth sets of longitudinally extending channels are adjacent to another one of the fourth longitudinally extending channels of the first, the second, the third, and the fourth sets of longitudinally extending channels.

18. A height adjustable charging grommet comprising:
a grommet sleeve having a sleeve wall and a flange at least partially circumscribing an outer portion of the sleeve wall, the grommet sleeve including a plurality of longitudinally extending channels on an inner portion of the sleeve wall, wherein each of the plurality of longitudinally extending channels incudes a pair of guide walls that are generally orthogonal to the inner portion of the sleeve wall and wherein a subset of the longitudinally extending channels each include a floor tab that extends between each of the pairs of guide walls, and wherein one or more of the floor tabs are positioned at varying heights relative to one another; and
a removeable grommet cap received within the grommet sleeve, the removeable grommet cap having a charging surface and one or more legs, wherein one or more of the legs fit between the pair of guide walls of a particular longitudinally extending channel of the plurality of longitudinally extending channels.

19. The height adjustable charging grommet of claim 18, wherein adjacent longitudinally extending channels, of the plurality of longitudinally extending channels, share a guide wall, of the pair of guide walls.

20. The height adjustable charging grommet of claim 18, wherein one or more of the floor tabs are positioned at the same height.
